(19) United States
(12) Patent Application Publication
(10) Pub. No.: US 2013/0324141 A1
(43) Pub. Date: Dec. 5, 2013

(54) METHOD AND APPARATUS FOR RRC CONNECTION ESTABLISHMENT IN MTC

(71) Applicants: Myung Cheul Jung, Seoul (KR); Ki Bum Kwon, Seoul (KR); Jae Hyun Ahn, Seoul (KR)

(72) Inventors: Myung Cheul Jung, Seoul (KR); Ki Bum Kwon, Seoul (KR); Jae Hyun Ahn, Seoul (KR)

(73) Assignee: Pantech Co., LTD, Seoul (KR)

(21) Appl. No.: 13/985,485

(22) PCT Filed: Feb. 16, 2012
(86) PCT No.: PCT/KR12/01178

§ 371 Date: Aug. 14, 2013

(30) Foreign Application Priority Data
Feb. 16, 2011 (KR) 10-2011-0013829

(51) Int. Cl. H04W 72/04

(52) U.S. Cl. CPC H04W 72/04
USPC 455/450

(57) ABSTRACT

The present invention relates to a method and an apparatus for RRC connection establishment in an MTC (Machine Type Communication) system. A method for RRC connection establishment of a BS according to the present invention comprises a step of determining a load status of a core network and a step of transmitting wait time information to an MTC UE by using an RRC connection reject message or RRC connection release message if the core network is found to be overloaded. At this time, the wait time information is recognized and used by a UE allowing a delay in establishing RRC connection; but the information is not recognized by a UE not allowing a delay in establishing RRC connection.

### CROSS-REFERENCE TO RELATED APPLICATIONS

This application is the National Stage Entry of International Application No. PCT/KR2012/001178, filed on Feb. 16, 2012 and claims priority from and the benefit of Korean Patent Application No. 10-2011-0013829, filed on Feb. 16, 2011 both of which are hereby incorporated by reference for all purposes as if fully set forth herein.

### BACKGROUND

1. Field

The present invention relates to wireless communication technology. More specifically, the present invention relates to machine type communication (MTC).

2. Discussion of the Background

Conventional wireless communication networks have been designed in consideration of human-to-human (H2H) communication. Allowing users to speak to each other through their handsets is the very basic function of most of current cellular networks; cellular networks are thus designed and operated to support the function as a baseline service.

In other words, conventional cellular networks have evolved from a network meant primarily for voice communication and thus their systems rely on the network architecture adapted for voice communication. Therefore, the conventional cellular networks have also been operated in such a way to support technical aspects inherent in the networks specialized in voice communication.

Nowadays, cellular networks are evolving from the existing systems based on voice communication into systems based on data communication, namely, those systems operated in the form of packet networks. Along with this change, handsets of various concepts are released into the market; particularly, smart phones may be regarded handsets meant primarily for data communication in units of packets, not to mention the conventional voice communication.

### SUMMARY

To realize MTC, the present invention has been made in an effort to provide a method and an apparatus capable of effectively controlling a request for establishing connection of UE in machine type communication (MTC).

To realize MTC, the present invention provides a method and an apparatus capable of effectively operating a network by differentiating connection establishment processes according to the type of UE in MTC.

To realize MTC, the present invention provides a method and an apparatus capable of effectively processing a procedure for a BS to establish connection according to the type of UE without determining the type of the corresponding UE.

One embodiment of the present invention is an RRC connection method for a BS in the MTC system, where the method comprises a step of determining the load imposed on the core network; and a step of transmitting wait time information to a UE by using an RRC connection reject message or an RRC connection release message if the core network is found to be overloaded. The wait time information can be recognized by a UE allowing a delay in establishing RRC connection and applied to the UE.

The wait time information may be transmitted only for an MTC terminal or a UE allowing a delay in establishing RRC connection. A BS can determine through a delay tolerant indicator received from a UE whether the UE is an MTC UE or a UE allowing a delay in establishing RRC connection. The indicator can be transmitted being included in an RRC connection request message or an RRC connection setup completion message of the UE.

The load conditions of the core network can be checked based on an overload generation message of the core network received from the MME. At this time, if the amount of load of the core network is currently higher than a predetermined first overload threshold value, the overload generation message can direct to apply measures according to the overload conditions for RRC connection requests of all of the UEs or only for RRC connections whereas the overload generation message can direct to apply measures according to the overload conditions only for MTC UEs or RRC connection requests of UEs allowing a delay in establishing RRC connection or RRC connections if the amount of load of the current core network is higher than a predetermined second overload threshold value and lower than the first overload threshold value. The overload generation message can include an overload processing indicator indicating whether to apply measures according to overload conditions of the core network for all of the UEs or MTC UEs or only for the UEs allowing a delay in establishing RRC connection; based on the indication of the overload processing message, the BS can apply the measures according to the overload conditions of the core network.

Another embodiment of the present invention is a method for establishing RRC connection of a UE in the MTC system. The method comprises a step of receiving wait time information through an RRC connection reject message or an RRC connection release message from a BS; and a step of transmitting an RRC connection request to the BS after the wait time specified in the wait time information is passed.

A UE, before receiving the wait time information, can transmit to a BS a delay tolerance indicator indicating that a delay in establishing RRC connection can be allowed. At this time, the delay tolerance indicator can be transmitted being included in an RRC connection request message. Also, the delay tolerance indicator can be transmitted being included in an RRC connection completion message.

The UE, before receiving the wait time information, decides whether to transmit to the BS a delay tolerance indicator indicating that a delay in establishing RRC connection can be allowed; if the UE determines transmission, the delay tolerance indicator can be transmitted to the BS. At this time, the delay tolerance indicator can be transmitted being included in an RRC connection request message or an RRC connection completion message.

Yet another embodiment of the present invention is a BS in the MTC system, the BS comprising a transmission and reception unit for transmitting and receiving messages for RRC setup; and a controller controlling RRC setup. The controller, determining that the core network is under overload conditions, can transmit wait time information to a UE by using an RRC (Radio Resource Control) connection reject message or an RRC connection release message, where the wait time information can be recognized by a UE allowing a delay in establishing RRC connection and applied for the UE.

The wait time information may be transmitted only for the MTC UEs or only for the UEs allowing a delay in establishing RRC connection and the base UE can determine through a delay tolerance indicator received from a UE whether the UE is an MTC UE or the UE allowing a delay in establishing RRC connection and the wait time information can be included in the RRC connection reject message or the RRC connection release message transmitted from the BS.

The controller can transmit a delay tolerance indicator to a BS through the transmission and reception unit, the delay tolerance indicator indicating that a delay in establishing RRC connection can be allowed before the wait time information is received. The delay tolerance indicator can be transmitted being included in the RRC connection request message or the RRC connection completion message.

In addition, the controller, before receiving the wait time information, can transmit to a BS a delay tolerance indicator indicating that a delay in establishing RRC connection can be allowed. At this time, the delay tolerance indicator can be transmitted being included in an RRC connection request message. Also, the delay tolerance indicator can be transmitted being included in an RRC connection completion message.

According to the present invention for MTC, UE can effectively control a connection establishment request.

According to the present invention for MTC, networks can be operated effectively by differentiating connection establishment processes according to the type of UE in MTC.

According to the present invention for MTC, a BS can effectively process a connection establishment procedure according to the type of UE without determining the type of the corresponding UE.

### BRIEF DESCRIPTION OF THE DRAWINGS

The accompany drawings, which are included to provide a further understanding of this document and are incorporated on and constitute a part of this specification illustrate embodiments of this document and together with the description serve to explain the principles of this document.

FIG. 1 is a block diagram illustrating a wireless communication system;

FIG. 2 is a block diagram illustrating a functional split between E-UTRAN and EPC;

FIG. 3 is a block diagram illustrating radio protocol architecture of a user plane;

FIG. 4 is a block diagram illustrating radio protocol structure of a control plane;

FIG. 5 briefly illustrates one example of employing M2M communication;

FIG. 6 also briefly illustrates one example of employing M2M communication;

FIG. 7 briefly illustrates the architecture of the 3GPP network for MTC;

FIG. 8 is a flow chart briefly illustrating a connection setup process in the case of MTC;

FIG. 9 is a flow chart briefly illustrating a case where a connection setup request of an MTC UE is rejected in the case of MTC;

FIG. 10 is a flow chart briefly illustrating a situation where RRC connection between a UE and a BS is released in the case of MTC;

FIG. 11 is a flow chart briefly illustrating the operation for RRC connection setup when a delay tolerance indicator is transmitted being included in an RRC connection request message in the case of MTC;

FIG. 12 is a flow chart briefly illustrating the operation for RRC connection setup when a delay tolerance indicator is transmitted being included in an RRC connection setup completion message in the case of MTC;

FIG. 13 is a flow chart briefly illustrating the operation of a BS about an MTC UE in a system to which the present invention is applied;

FIG. 14 is a flow chart briefly illustrating the operation among an MTC UE, a BS, and an MME in an embodiment 1 where a delay tolerance indicator is not taken into account in a system to which the present invention is applied;

FIG. 15 is a flow chart briefly illustrating the operation of a BS of the embodiment 1 in terms of transmission of extended wait time information;

FIG. 16 is a flow chart briefly illustrating the operation of an MTC UE of the embodiment 1 processing extended wait time information;

FIG. 17 is a flow chart briefly illustrating the operation between an MTC UE, a BS, and an MME in an embodiment 2 where a delay tolerance indicator is taken into account in a system to which the present invention is applied;

FIG. 18 is a flow chart briefly illustrating the operation of a BS of the embodiment 2 in terms of transmission of extended wait time information;

FIG. 19 is a flow chart briefly illustrating the operation of an MTC UE of the embodiment 2 processing extended wait time information;

FIG. 20 is a flow chart briefly illustrating the operation of an MME in the embodiment 1 and 2; and

FIG. 21 briefly illustrates the configuration of an MTC UE, a BS, and an MME in a system to which the present invention is applied.

### DETAILED DESCRIPTION OF THE ILLUSTRATED EMBODIMENTS

The present invention relates to a method for establishing connection between an MTC (Machine Type Communication) type UE and a system in a wireless communication system employing MTC. More specifically, the present invention relates to a method for effectively controlling a plurality of MTC type UEs when the UEs attempt to establish connection to a system simultaneously. Connection establishment for an MTC UE can be controlled by taking account of a delay tolerance indicator included a connection establishment request (e.g., RRC connection establishment) according to load conditions of a core network (CN) to which the MTC UE attempts to establish connection.

In addition, the present invention provides a method of controlling connection establishment for a connection establishment request in which a delay tolerance indicator is not included.

Hereinafter, this document describes technical details of the present invention with reference to illustrative drawings and embodiments accompanying the present invention. In assigning reference symbols to constituting elements of each drawing, it is intended to assign the same reference symbols as possibly as can be for the same constituting elements even if the elements are used in different drawings. Moreover, for the purpose of describing an embodiment of the present invention, if it is determined that composition of facts known in the art or specific description of a function may cause misunderstanding of the technical principles of the present invention, the corresponding description can be omitted.

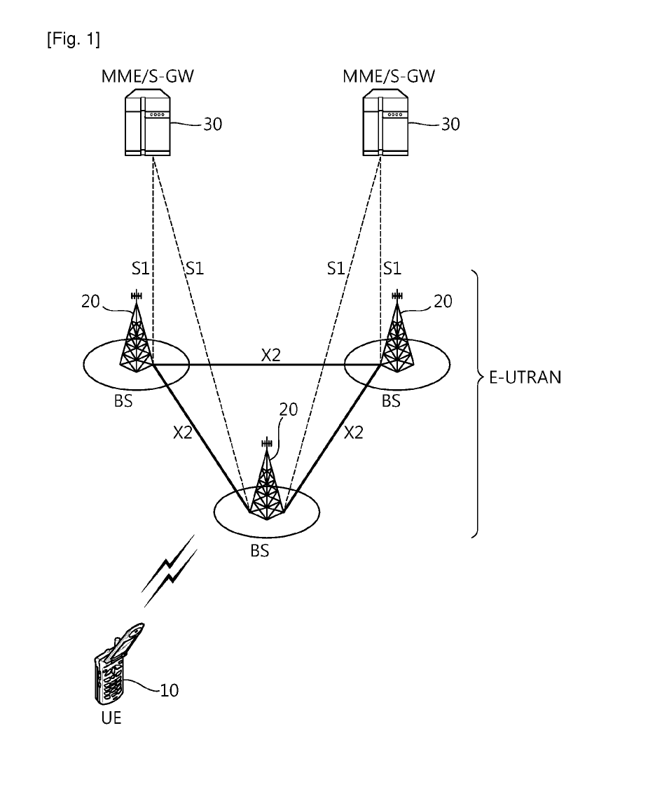

FIG. 1 is a block diagram illustrating a wireless communication system. The block diagram may correspond to the network structure of the 3GPP LTE/LTE-A. E-UTRAN (Evolved-UMTS Terrestrial Radio Access Network) includes a base station (BS) 20 providing a control plane and a user plane for a user equipment (UE) 10.

The UE 10 may be fixed or mobile and can be called differently such as an MS (Mobile Station), a UT (User UE), an SS (Subscriber Station), an MT (Mobile UE), or a wireless device.

A BS 20 denotes a fixed station communication with a UE 10 and can be called differently such as an eNB (evolved-NodeB), a BTS (Base Transceiver System), or an access point.

A single BS 20 can comprise one or more cells. At this time, a cell should be interpreted comprehensively as a part of the area covered by the BS 20, including various sizes of coverage area such as a mega cell, a micro cell, a pico cell, a femto cell, and a relay.

An interface may be used between BSs 20 for user traffic or control traffic transmission. The BSs 20 can be connected to one another through X2 interface.

The BS 20 is connected to EPC (Evolved Packet Core) through S1 interface, more specifically, to MME (Mobility Management Entity) through S1-MME and to S-GW (Serving GateWay) through S1-U. The S1 interface supports many-to-many relationship between the BS 20 and MME/SAE gateway 30.

In what follows, downlink transmission denotes communication from the BS 20 to the UE 10 while uplink transmission from the UE 10 to the BS 20. In downlink transmission, a transmitter may be a part of the BS 20 while a receiver a part of the UE 10. Likewise, in uplink transmission, the transmitter may be a part of the UE 10 while the receiver a part of the BS 20.

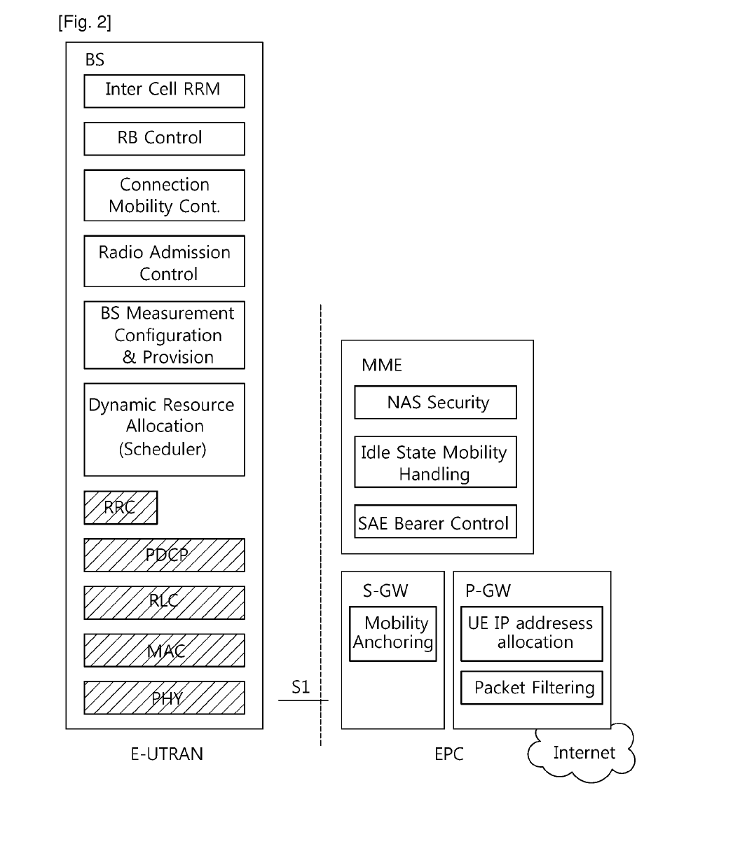

FIG. 2 is a block diagram illustrating a functional split between E-UTRAN and EPC. A box with oblique lines represents a radio protocol layer and a white box represents a functional entity of a control plane. In what follows, functions of functional entities are described.

The BS performs the following functions: (1) Radio resource management (RRM) function such as radio bearer control, radio admission control, connection mobility control, and dynamic resource allocation toward a UE, (2) IP (Internet Protocol) header compression and encryption of user data streams, (3) Routing of user plane data toward S-GW, (4) Scheduling and transmission of a paging message, and (5) Scheduling and transmission of broadcast information. (6) Measurement of mobility and measurement report setup.

MME performs the following functions: (1) NAS (Non-Access Stratum) signaling, (2) NAS signaling security, (3) Idle mode UE reachability, (4) Tracking area list management, (5) Roaming, and (6) Authentication.

S-GW performs the following functions: (1) Mobility anchoring and (2) Lawful interception.

P-GW (PDN-Gateway) performs the following functions: (1) UE IP allocation and (2) Packet filtering.

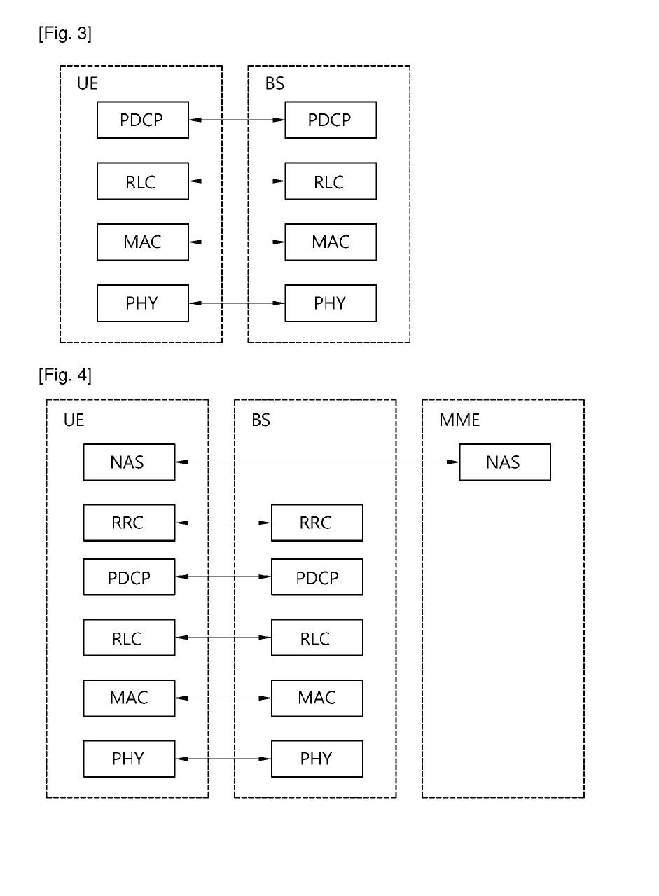

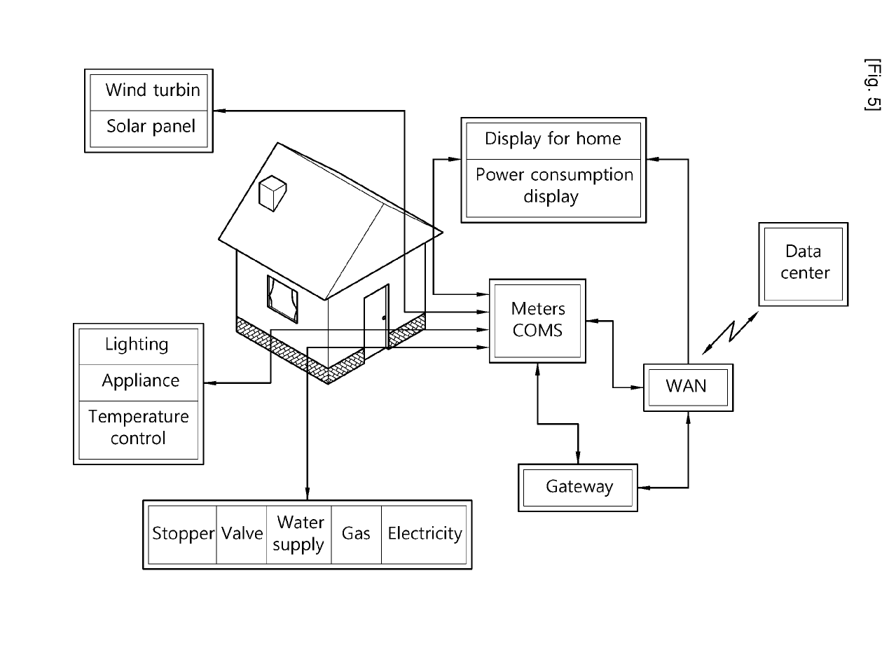

FIG. 3 is a block diagram illustrating radio protocol architecture of a user plane. FIG. 4 is a block diagram illustrating radio protocol structure of a control plane. The user plane is a protocol stack for user data transmission and the control plane is a protocol stack for control signal transmission.

With reference to FIGS. 3 and 4, a physical layer (PHY) provides an information transfer service for its upper layer by using a physical channel. The physical layer is connected to its upper layer, MAC (Medium Access Control) layer, through a transport channel.

Data move between the MAC layer and the physical layer through the transport channel. The transport channel can be classified in various ways according to how data are transferred through a radio interface and with what characteristics.

Between different physical layers, namely, physical layers of a transmitter and a receiver, data are transferred through the physical layer. A physical control channel can be used for the physical layer.

The function of the MAC layer includes mapping between a logical channel and the transport channel; and multiplexing/demultiplexing of transport blocks provided for the physical channel through the transport channel of a MAC SDU (Service Data Unit). The MAC layer provides a service for an RLC (Radio Link Control) layer through the logical channel.

The function of the RLC layer includes concatenation, segmentation, and reassembly of the RLC SDU. To ensure QoS (Quality of Service) in various levels demanded by a radio bearer (RB), the RLC layer provides three operating modes: Transparent Mode (TM), Unacknowledged Mode (UM), and Acknowledged Mode (AM). AM RLC provides error correction through ARQ (Automatic Repeat reQuest).

The function of a PDCP (Packet Data Convergence Protocol) layer in the user plane includes transfer of user data, header compression, and ciphering. The function of the PDCP layer in the user plane includes transfer of control plane data and ciphering/integrity protection.

An RRC (Radio Resource Control) layer is defined only in the control plane. The RRC layer handles control of the logical, transport, and physical layer in association with configuration, re-configuration, and release of radio bearers.

An RB denotes a logical path provided by a first layer (PHY layer) and a second layer (MAC layer, RLC layer, PDCP layer) for data transfer between a UE and a network. Setting up an RB denotes a procedure of specifying characteristics of a radio protocol layer and channel to provide a particular service and determining individual parameters and operating methods. An RB can be further divided into SRB (Signaling RB) and DRB (Data RB). SRB is used as a path through which messages are transferred while DRB as a path through which user data are transferred in the user plane.

A NAS (Non-Access Stratum) layer placed on top of the RRC layer performs a function of session management, mobility management, and so on.

Meanwhile, besides H2H (Human-To-Human) communication meant for services based primarily on voice communication, M2M (Machine-To-Machine) communication featuring data communication is under discussion. M2M communication is a communication service based primarily on data communication, enabling communication among machines such as peer servers, handsets, etc.

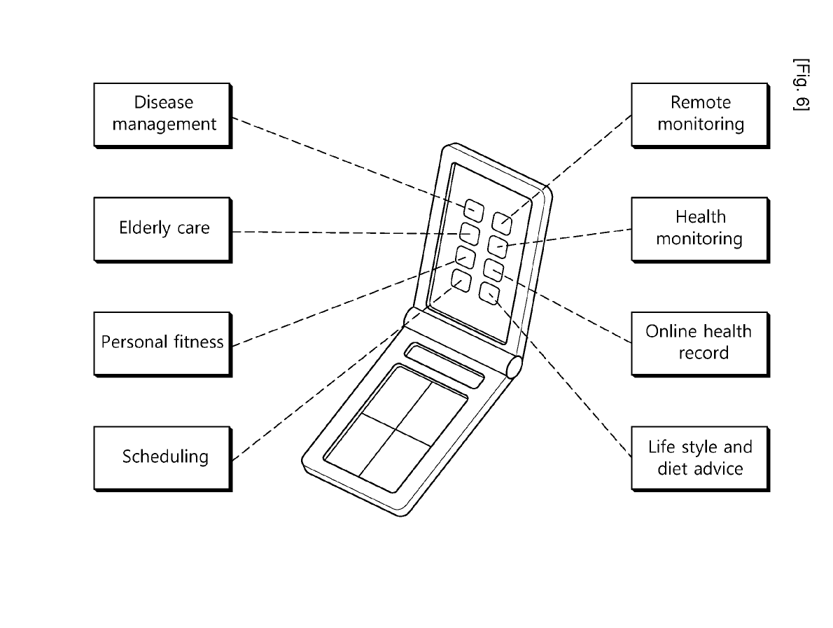

FIG. 5 briefly illustrates one example of employing M2M communication.

Smart metering is a typical example for which M2M communication is applied and also a service model most considered by service providers regarding M2M communication. With reference to FIG. 5, measured values from various sensors and/or devices installed inside or outside a building are transmitted through a network of a service provider and the service provider can take appropriate measures by using the information gathered in such a way.

FIG. 6 also briefly illustrates one example of employing M2M communication.

FIG. 6 conceptually shows one example where M2M communication is used for the purpose of managing a user's health. In other words, body information of the user is collected through various sensors attached to the user's body, where the information can later be used for remote monitoring, health check, etc.

As described above, a communication method used for providing an M2M communication service is called MTC (Machine Type Communication). Also, a handset or various other devices for providing various services through MTC or utilizing the services are called an MTC device or an MTC UE (hereinafter, ‘MTC UE’ is used as a terminology including MTC devices as well).

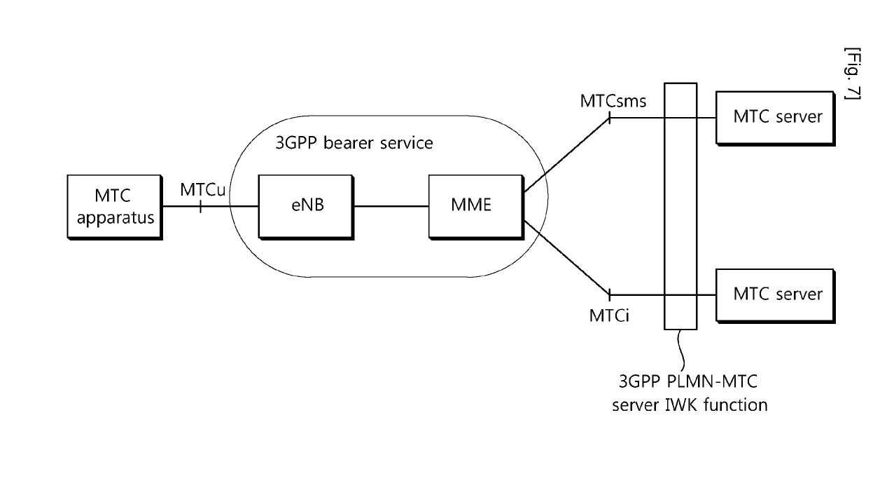

FIG. 7 briefly illustrates the architecture of the 3GPP network for MTC.

With reference to FIG. 7, an MTC UE can communicate with an MTC server through the 3GPP network. In the case of the EPS (Evolved Packet System) network supporting LTE (Long-Term Evolution), an MTC device or an MTC UE can be connected to an MTC server by way of eNB and MME.

On the other hand, though not shown in the figure, in the existing UMTS (Universal Mobile Telecommunications System) network supporting WCDMA (Wideband Code Division Multiple Access), an MTC UE can communicate with an MTC server by passing through an NB, UTRAN, SGSN (Serving General packet radio Support Node), GGSN (Gateway General packet radio service Support Node), etc.

In the case of MTC, RRC connection should be established between an MTC terminal and a BS to enable communication.

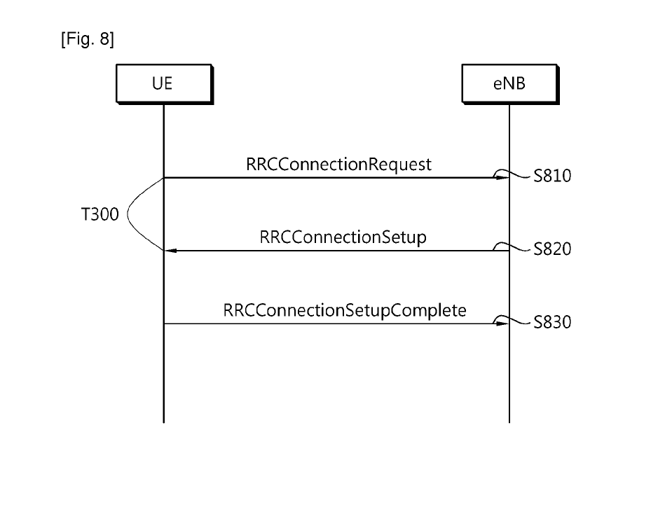

FIG. 8 is a flow chart briefly illustrating a connection setup process in the case of MTC.

With reference to FIG. 8, an MTC UE (UE) transmits a RRC connection request message (RRCConnectionRequest) requesting RRC connection establishment to a BS at S810. The RRC connection request message is a message sent by an MTC UE at the beginning to a BS for establishing RRC connection. At this time, a timer in the MTC UE, known as T300, starts to operate and if a response is not received from the BS until the T300 timer is expired, the RRC connection request message is transmitted again.

The RRC connection request message includes a UE ID (Identity), establishment cause, etc. The UE ID is identification information of an MTC UE. The establishment cause is information related to a cause for which the MTC UE makes a request for connection establishment, including emergency, high priority access, mt-access, mo-signaling, mo-data, etc. At this time, mt-access is a connection establishment request for a mobile terminate call and mo-signaling is a signaling connection establishment request for a mobile originated call and mo-data is a connection establishment request for a mobile originated call.

The BS, in the case of allowing connection, transmits an RRC connection setup message (RRCConnectionSetup) including an initial radio resource configuration to the MTC UE at S820. The RRC connection setup message can include information about configuration of radio layers such as RLC, MAC, PHY, etc. and resource assignment. The BS, instead of signaling for each parameter, can command the MTC UE to apply a default configuration provided in RRC specifications.

The T300 timer expires before completion when the RRC connection establishment message is received.

The MTC UE returns an RRC connection setup completion message (RRCConnectionSetupComplete) indicating completion of RRC connection establishment to the BS at S830. The UE completes the RRC setup by receiving the RRC connection setup message and informs the BS of completion of setup for RRC connection through the RRC connection setup completion message.

The RRC connection setup completion message may include a NAS (Non Access Stratum) message and the NAS message triggers S1 connection establishment, thereby initiating a subsequent procedure through which E-UTRAN activates AS (Access Stratum) security and SRB (Signaling Radio Bearer) 2, DRB (Data Radio Bearer), etc. are established. Also, the RRC connection setup completion message may include PLMN (Public Land Mobile Network)-ID used to support network sharing, MME-ID of a registered MME provided by an upper layer, and NAS dedicated information.

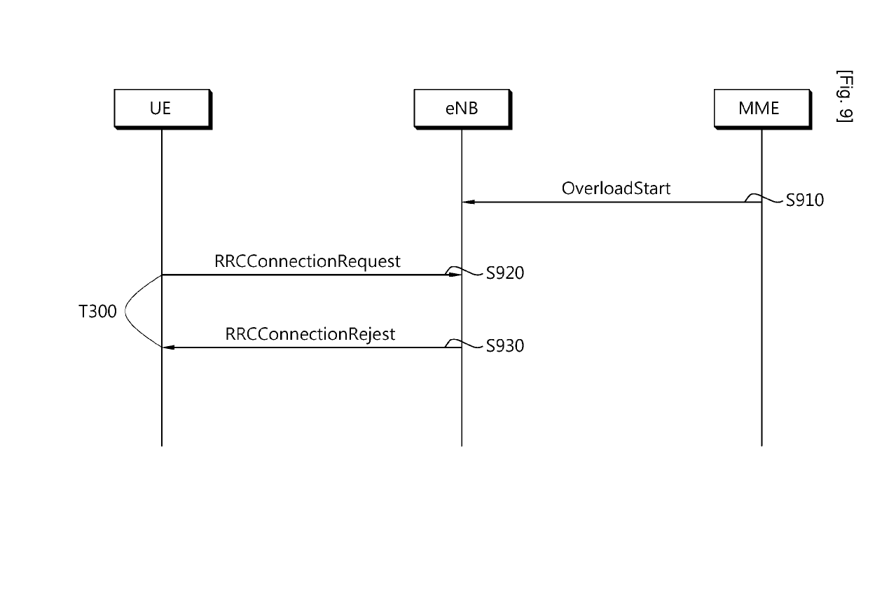

FIG. 9 is a flow chart briefly illustrating a case where a connection setup request of an MTC UE is rejected in the case of MTC.

With reference to FIG. 9, before an MTC UE requests an RRC connection establishment, a BS receives an overload start message (OverloadStart) from an MME indicating that a core network (CN) begins to be overloaded at S910. Through the overload start message, the BS can recognize that the core network has begun to be overloaded.

While the BS recognizes the overload on the core network, the MTC UE initiates the T300 timer and transmits the RRC connection request message to the BS at S920.

If the RRC connection request message is received from the MTC UE, since the BS already knows the occurrence of overload on the core network, the BS transmits an RRC connection reject message (RRCConnectionReject) to the MTC UE at S930. If the RRC connection reject message is received, the T300 timer is stopped.

At this time, the RRC connection reject message includes information about waiting time. Therefore, the MTC UE receiving the RRC connection reject message, after a wait timer for the waiting time is completed, that is, after a waiting time is passed, can transmits a new RRC connection request message to the BS.

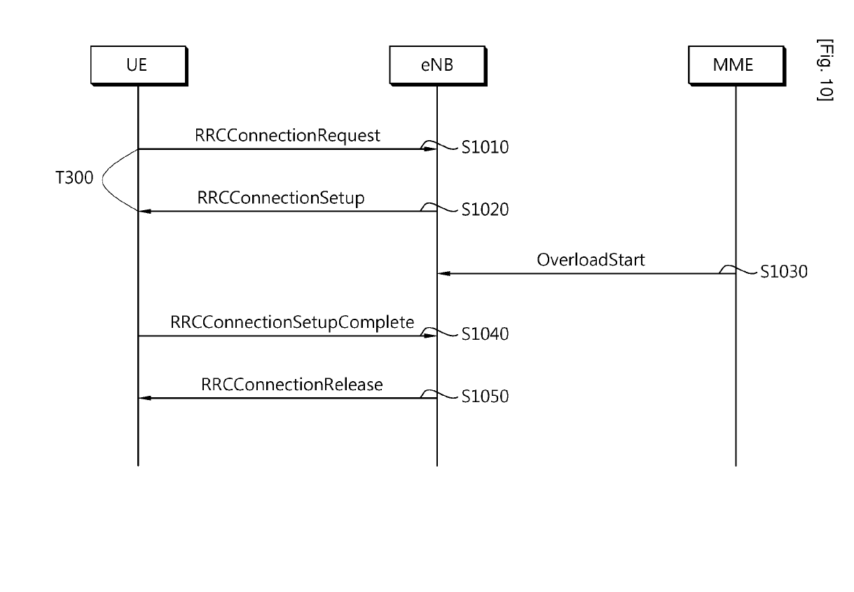

FIG. 10 is a flow chart briefly illustrating a situation where RRC connection between a UE and a BS is released in the case of MTC.

An MTC UE initiates the T300 timer and transmits an RRC connection request message to a BS at S1010.

The BS, which has received the RRC connection request message from the MTC UE, transmits an RRC connection setup message to the MTC UE at S1020.

The BS, after transmitting the RRC connection setup message to the MTC UE, receives an overload start message indicating occurrence of overloading from the MME at S1030.

At this time, too, the MTC UE transmits the RRC connection setup completion message in response to the RRC connection setup message received from the BS at S1040.

Already knowing the occurrence of overloading in the core network, the BS transmits an RRC connection release message (RRCConnectionRelease) commanding release of the RRC connection to the MTC UE at S1050. The RRC connection release message is a message transmitted by the BS to make the MTC UE release the RRC connection. The RRC connection release message can include information about a cause for releasing connection such as LoadBalancingTAURequired.

As the BS transmits the RRC connection release message, connection between the BS and the MTC UE is released.

The description above assumed that the information indicating overload (overload start message) is transmitted from the MME to the BS after transmission of the RRC connection setup message and before receiving the RRC connection setup completion message, which is meant for the convenience of description; in the case where the overload start message arrives after RRC connection is established, RRC connection can be released in the same manner. For example, even if the overload start message arrives after the RRC connection setup completion message is received, the BS can release the RRC connection by transmitting the RRC connection release message to the MTC UE.

Also, although the description above assumed that RRC connection request is rejected or RRC connection is released when the core network begins to be overloaded, the assumption is meant for the convenience of description; RRC connection can be rejected or released due to various causes.

Although descriptions with reference to FIGS. 8 to 10 correspond to the case of an MTC UE, the descriptions are not limited to the above but can be applied to general type UEs.

Meanwhile, in the case of an MTC, a plurality of MTC UE can exist within a particular area. For example, in the case of FIG. 5, it is often the case that a plurality of MTC UEs should report information to a peer or an MTC server simultaneously. In this case, a problem may arise from various aspects of a network. For example, a RAN (Radio Access Network) may run short of radio resources as radio resources are accessed simultaneously at a particular time. Also, a CN (Core Network) may begin to be overloaded instantaneously as the network is overwhelmed by requests for connection establishment at a particular time.

In the case of MTC UE, different from devices or UEs for H2H communication, no serious problem may occur though RRC connection may take some time to be established; in this case, by delaying the time for connection of the MTC UE to the network a little, occurrence of shortage of radio resources and/or overload described above can be prevented.

In this regard, the MTC UE can transmit the message for RRC connection setup to the BS by incorporating a delay tolerance indicator. At this time, the message for RRC connection setup may correspond to the RRC connection request message or the RRC connection setup completion message.

An indicator for connection delay transmitted being included in a message for RRC connection setup is called a delay tolerance indicator. The delay tolerance indicator informs the network that an MTC UE is in a situation where a certain level of delay can be tolerated for network connection, that is, RRC connection establishment. A UE can be divided into an MTC UE which can tolerate delay in RRC connection setup (hereinafter, it is called a ‘delay tolerance UE’) and a non-MTC UE or an MTC UE which does not allow delay (hereinafter, it is called a ‘delay non-tolerance UE’); the delay tolerance indicator can be used in delay tolerance UEs.

Meanwhile, a single MTC UE can be used as a ‘delay tolerance UE’ or a ‘delay non-tolerance UE’ depending on situations. In some cases, a single non-MTC UE can be used as a ‘delay tolerance UE’ or a ‘delay non-tolerance UE’ depending on situations. In the above description, an MTC UE or a non-MTC UE is used as a ‘delay tolerance UE’ and a ‘delay non-tolerance UE’ due to the aspect of a service provided by the UE rather than the characteristics inherent in the UE itself.

For example, various services can be provided at the same time by a single UE; an MTC UE or a non-MTC UE both can provide a ‘delay tolerance service’ or a ‘delay non-tolerance service’. In the case of utilizing a ‘delay tolerance service’, the UE can be used as a ‘delay tolerance UE’ while the same UE can be used as a ‘delay non-tolerance UE’ in the case of is using a ‘delay non-tolerance service’.

A BS receiving a delay tolerance indicator can delay RRC connection establishment of an MTC UE which has transmitted a delay tolerance indicator by rejecting an RRC connection setup request or releasing established RRC connection according to the conditions of the core network (e.g., conditions of network overload).

For the convenience of description, it was assumed in the above that a delay tolerance indicator is used as an indicator to indicate that a delay can be tolerated depending on the conditions of the core network; however, the delay tolerance indicator is not limited to the above and can be used as an indicator indicating that a delay can be tolerated by taking account of the conditions (e.g., conditions of network overload) of the RAN (Radio Access Network).

Meanwhile, depending on the conditions of a network, for example, in the case of occurrence of network overload, the BS can transmit an RRC connection reject message or an RRC connection release message to an MTC UE by incorporating information about extended wait time (eWaitTime) while either rejecting an RRC connection request or releasing established RRC connection.

Different from the conventional waiting time, the extended wait time (eWaitTime) is information controlled by the NAS layer; in the case of the LTE system, the extended wait time can be set up by a BS or a core network. This is because the extended wait time (eWaitTime) is information controlled by the NAS layer and thus, more appropriate value can be assigned by the core network handling the NAS layer.

In the case of the WCDMA system, the extended wait time can be assigned by the network. In the case of a UE, too, a response method and/or a processing method when extended wait time is applied can be set up and operated by the NAS layer or the AS layer of the UE.

The extended wait time is the information assigned to an MTC UE such that in the case RRC connection between the MTC UE and the BS is rejected or released, a predetermined time delay can be allowed until the MTC UE issues an RRC connection request again by taking the conditions (e.g., conditions of network overload) of the core network into consideration. For example, in a situation where overload occurs in the core network and an RRC connection request message is transmitted from the MTC UE to the BS, the BS can transmit an RRC connection reject message incorporating information about extended wait time to the MTC UE. Also, after RRC connection is established, if network overload occurs, the BS can transmit an RRC connection release message incorporating information about extended wait time to the MTC UE.

The extended wait time can be set up in units of seconds, ranging from a few seconds to a few hours and the setup can be changed.

An MTC UE which has received an RRC connection reject message or an RRC connection release message incorporating information about the extended wait time may retry RRC connection establishment after a delay amounting roughly to the received extended wait time. Therefore, requests for RRC connection establishment concentrated at a particular time can be spread and thus, the load of the core network can be controlled.

For the convenience of description, the extended wait time has been described as a means of controlling the core network by taking into account the conditions of the core network (e.g., conditions of network load); however, the extended wait time is not limited to the above and can also be used as a means of controlling the RAN (Radio Access Network) by taking into account the conditions thereof (e.g., conditions of network load).

Meanwhile, the delay tolerance indicator and the extended wait time (eWaitTime) can be applied in association with each other. For example, a BS may apply the extended wait time only for the RRC connection request message or the RRC connection setup completion message incorporating the delay tolerance indicator.

The extended wait time may be applied only for a delay tolerance UE. Therefore, if the RRC connection request message or the RRC connection setup completion message transmitted by an MTC UE includes the delay tolerance indicator and as a result, the corresponding MTC UE is found to be a delay tolerance MTC UE, information about the extended wait time can be transmitted being included in the RRC connection reject message or the RRC connection release message. When information about the extended wait time is transmitted to a delay non-tolerance UE, the delay tolerance UE may ignore the information about extended wait time or may not recognize a field about extended wait time.

FIG. 11 is a flow chart briefly illustrating the operation for RRC connection setup when a delay tolerance indicator is transmitted being included in an RRC connection request message in the case of MTC.

With reference to FIG. 11, a BS recognizes the occurrence of overload in the core network by receiving a message from the MME before the RRC connection request message is received from an MTC UE at S1110.

Different from FIG. 9, the MTC UE of FIG. 11 transmits a delay tolerance indicator indicating that the MTC UE is a delay tolerance UE by incorporating the delay tolerance indicator into the RRC connection request message at S1120. At this time, the delay tolerance indicator may correspond to a cause value for RRC connection establishment.

Recognizing the occurrence of overload in a current core network, the BS confirms the corresponding UE to be a delay tolerance UE through the delay tolerance message included in the RRC connection request message received from the MTC UE and transmits an RRC connection reject message to the corresponding UE at S1130. At this time, the BS can apply extended wait time for the corresponding UE and transmit information about the extended wait time by incorporating the information into the RRC connection reject message.

The MTC UE which has received the RRC connection reject message checks the information about extended wait time included in the RRC connection reject message and waits for the period of the extended wait time without attempting RRC connection establishment. The method of waiting without attempting RRC connection establishment during the extended wait time is one example of applying the extended wait time (eWaitTime) and various methods for avoiding simultaneous connection requests from MTC UEs can be additionally taken into account.

The BS receives an overload end message (OverloadEnd) from the MME, indicating that overload in the core network has ended at S1140. The BS, through the overload end message received, can recognize that the overload in the core network has ended.

The MTC UE re-transmits the RRC connection request message to the BS after extended wait time at S1150. In this case, too, the MTC UE can transmit the delay tolerance indicator by incorporating the indicator into the RRC connection request message. With reference to FIG. 11, since overload of the core network has ended, RRC connection can be established normally.

In the above, for the convenience of description, it was assumed that overload of the core network is ended before the extended wait time is expired; if overload of the core network is not ended even when the extended wait time is passed and the MTC UE re-transmits the RRC connection request message, the BS can re-transmit the RRC connection reject message including extended wait time information to the MTC UE.

Different from the case of FIG. 11, the delay tolerance indicator can be included in the RRC connection setup completion message.

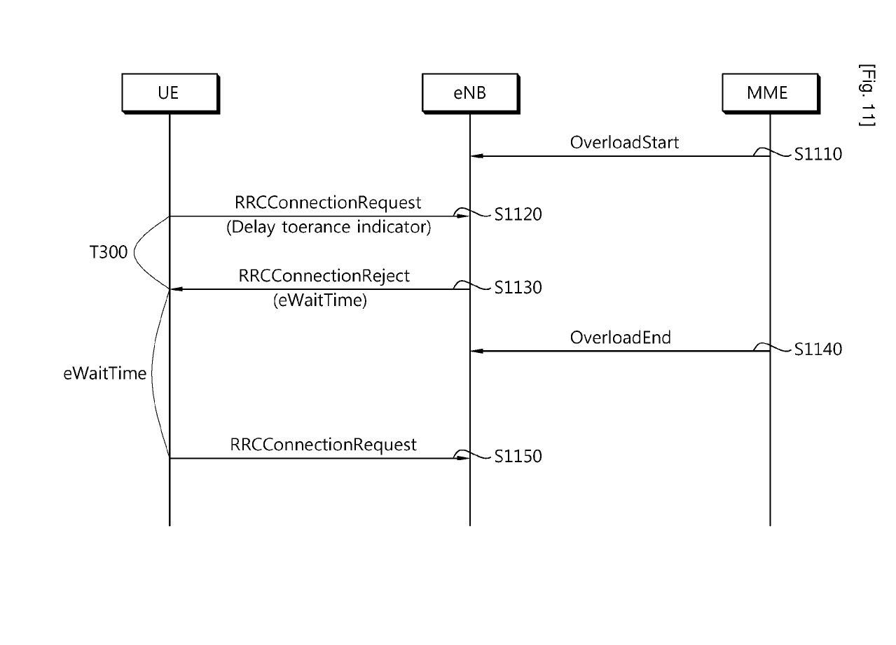

FIG. 12 is a flow chart briefly illustrating the operation for RRC connection setup when a delay tolerance indicator is transmitted being included in an RRC connection setup completion message in the case of MTC.

With reference to FIG. 12, a BS receives an overload start message informing of overload occurrence in the core network from the MME at S1210.

Afterwards, the BS receives an RRC connection request message from an MTC UE at S1220. Different from FIG. 11, in the case of FIG. 12, the delay tolerance message is not included in the RRC connection request message.

The BS transmits the RRC connection setup message to the MTC UE at S1230.

The UE establishes RRC connection based on the RRC connection setup message received from the BS and transmits the RRC connection setup completion message to the BS at S1240. At this time, the RRC connection setup completion message includes the delay tolerance indicator.

The BS, already knowing the overloaded state of the core network, checks the delay tolerance indicator included in the RRC connection setup completion message and transmits the RRC connection release message to the MTC UE at S1250. At this time, the RRC connection release message includes information about extended wait time.

The MTC UE receives the RRC connection release message and after a time delay of the extended wait time, re-transmits the RRC connection request message to the BS at S1270.

If the BS knows that overload of the core network has ended by receiving an overload end message informing of the end of overload of the core network from the MME at S1260, RRC connection of the MTC UE can be established in a normal manner.

As described above, in the cases of FIGS. 11 and 12, by rejecting the RRC connection request or releasing the RRC connection selectively for a delay tolerance UE through a delay tolerance indicator, overload of the core network can be controlled effectively and concentration of connection requests on an MTC server can be prevented.

However, if overload occurs in the core network, in other words, if the BS receives from the MME the overload start message (OverloadStart) informing of occurrence of overload in the core network, subsequent RRC connection requests are all rejected in most cases. Consequently, for both cases of FIGS. 11 and 12, except for a special case due to an emergency call, the RRC connection request of the delay tolerance UE is hard to be rejected selectively or RRC connection of the delay tolerance UE is hard to be released selectively. Therefore, to control the network overload effectively by selectively handling the delay tolerance UE even for a case where overload occurs in the core network, methods such as described in (1) and (2) below may be taken into consideration.

(1) A method not taking account of delay tolerance indicator

A case where transmission of a delay tolerance indicator is not optional: A delay tolerant MTC UE transmits an RRC connection request message or an RRC connection setup completion message by incorporating a delay tolerance message into the message. A BS, recognizing overload of a core network, transmits an RRC connection reject message including extended wait time information to the MTC UE irrespective of whether the delay tolerance indicator is included in the RRC connection request message. Since it can be checked whether the corresponding MTC UE is a delay tolerant UE after an RRC connection setup completion message is received, however, it can be such that an RRC connection release message including extended wait time information is transmitted only to an MTC UE checked by a delay tolerance indicator.

A case where transmission of a delay tolerance indicator is optional: In this case, even though a delay tolerance indicator is transmitted being included in an RRC connection request message to a BS, the delay tolerance indicator may or may not be included in the RRC connection request message depending on a situation. In the same way, even if it is determined such that the delay tolerance indicator is transmitted being included in the RRC connection request message to a BS, the delay tolerance indicator may or may not be included in the RRC connection setup completion message depending on a situation. As a result, the BS may not be able to determine whether the corresponding UE is a delay tolerant UE even after receiving the RRC connection setup completion message. Therefore, the BS, if overload of a core network is recognized, transmits an RRC connection reject message or an RRC connection release message including extended wait time information to the UE irrespective of whether the delay tolerance indicator is included in the RRC connection request message or the RRC connection setup completion message.

For both cases where transmission of a delay tolerance indicator is optional or non-optional, if an MTC UE receiving the extended wait time information turns out to be a delay tolerant UE, the UE waits for a time period as long as the extended wait time and re-transmits an RRC connection request message to the BS. Meanwhile, if an MTC UE receiving extended wait time information corresponds to a delay non-tolerant UE, the extended wait time information may be ignored or the corresponding field may be skipped for recognition. Therefore, MTC UEs utilizing the delay tolerance indicator can be dealt with selectively.

(2) A method taking account of delay tolerance indicator.

An overload start message (OverloadStart) coming from an MME to a BS can be interpreted or defined to be rejecting an RRC connection request or releasing RRC connection if an MTC UE or a delay tolerant UE satisfies predetermined conditions. On the other hand, it is equally possible that another overload start message is defined only for an MTC UE or a delay tolerant UE in such a way to reject the corresponding RRC connection request or release the corresponding RRC connection; and the MME selectively transmits a message more appropriate for current network conditions between the existing overload start message specifying rejection of all of subsequent RRC requests and the newly defined overload start message. In this way, a delay tolerant UE or an MTC UE is enabled to carry out the RRC connection setup procedure independently. At this time, various methods can be employed to determine whether a UE corresponds to a delay tolerant UE or an MTC UE, which can also be checked through a delay tolerance indicator.

In what follows, for the convenience of description, an overload start message for rejecting all the RRC connection requests subsequent to the occurrence of overload is called a global overload start message while an overload start message defined or interpreted only for an MTC UE or a delay tolerant UE for rejecting the corresponding RRC connection request or releasing the corresponding RRC connection is called an MTC overload start message. The global overload start message and the MTC overload start message may be defined in separate forms from each other; at the same time, the same form of overload start message may be employed but an identifier is included to distinguish one from the other.

As described above, the MTC overload start message may correspond to an indicator indicating rejection of an RRC connection request or release of established RRC connection for an MTC UE or a delay tolerance UE. Also, the MTC overload start message may correspond to an indicator indicating rejection of an RRC connection request or release of established RRC connection for an MTC UE or a delay tolerant UE when predetermined conditions are met.

For example, the MTC overload start message can be composed by incorporating an identifier applied for an MTC UE or a delay tolerant UE.

Also, the MTC overload start message can be composed in such a way to reject an RRC connection request or release established RRC connection for an MTC UE or a delay tolerant UE.

Furthermore, the MTC overload start message can be composed by setting a flag to distinguish between the case where overload conditions of a core network are applied to an MTC UE or a delay tolerant UE and the case where the conditions are applied for all of UEs. For example, if the flag is 0, it can be made that RRC connection requests are rejected or established RRC connections are released for all the UEs, while RRC connection requests are rejected or established RRC connections are released for MTC UEs or delay tolerant UEs in the case when the flag is 1.

In addition, the MTC overload start message can be composed such that in consideration of overload conditions of the core network, RRC connection requests are rejected or established RRC connections are released in a stepwise manner for MTC or delay tolerant UEs and all of UEs. To be specific, it can be composed such that a first overload ratio which is threshold for overload ratio applied to all of UEs and a second overload ratio which is threshold for overload ratio applied to an MTC UE or a delay tolerant UE are determined and information about overload ratio of a current core network is included in the overload start message transmitted from the MME. At this time, if the overload ratio of the core network is higher than the first overload ratio, RRC connection requests are rejected or established RRC connections are released for all of UEs, while if the overload ratio of the core network is lower than the first overload ratio but higher than the second overload ratio, RRC connection requests are rejected or established RRC connections are released for MTC or delay tolerant UEs.

On the other hand, the overload start message can include information about extended wait time. It is because the MME may be the most appropriate node which determines extended wait time information transmitted to a UE from a BS and the extended wait time information may correspond to the time information actually applied or used for the NAS layer. In this case, the BS can transmit the extended wait time information received from the MME to a UE by incorporating the information into the RRC connection reject message or the RRC connection release message.

For example, the overload start message can include extended wait time information as follows: OverloadStart (eWaitTime IE: 1 sec ˜more than a few hours).

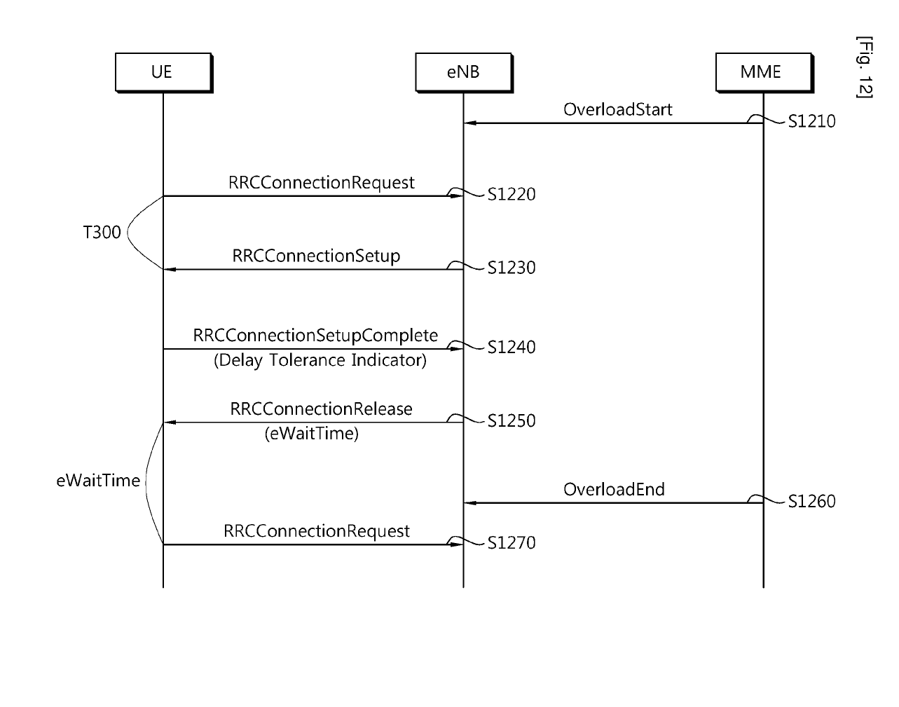

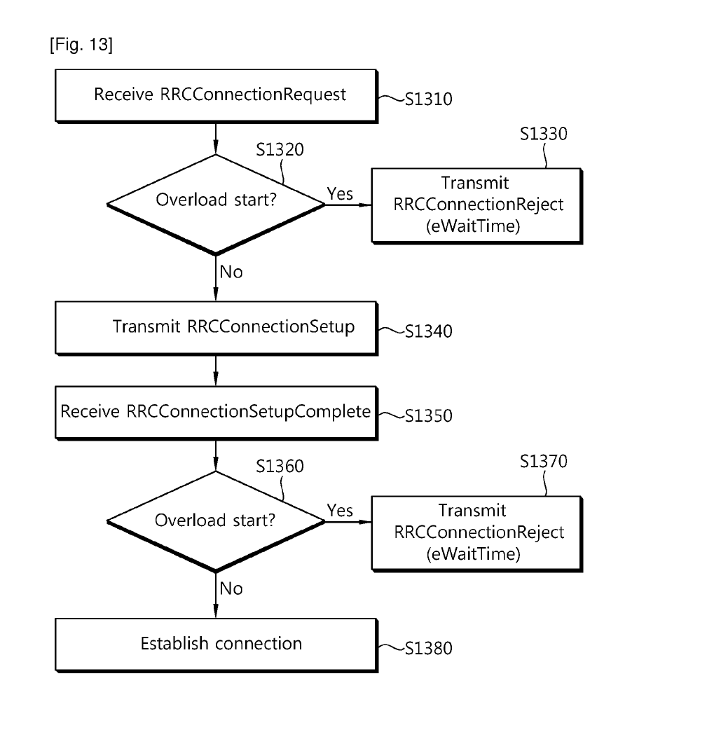

FIG. 13 is a flow chart briefly illustrating the operation of a BS about an MTC UE in a system to which the present invention is applied.

ABS receives an RRC connection request message from an MTC UE at S1310.

A delay tolerance indicator may be included in the RRC connection request message or RRC connection setup completion message. As described above, even if it is assumed that the delay tolerance indicator is transmitted being included in the RRC connection request message, the RRC connection request message can be transmitted without incorporating the delay tolerance indicator depending on situations. Therefore, the delay tolerance indicator may or may not be included in the RRC connection request message received by the BS from the MTC UE.

The BS determines whether overload has occurred in the core network by recognizing conditions of the core network at S1320. The BS can determine occurrence of overload in the core network based on an overload start message received from the MME.

At this time, the overload start message may correspond to the global overload start message or MTC overload start message.

If a method not taking account of delay tolerance indicator is employed, the BS can determine occurrence of overload in the core network based on the global overload start message. Receiving the global overload start message from the MME, the BS can determine occurrence of overload in the core network.

In the case of employing a method taking account of delay tolerance indicator, the BS can determine occurrence of overload in the core network based on the MTC overload start message. The BS, receiving the MTC overload start message from the MME, can apply overload conditions of the core network for an MTC or delay tolerant UE. Whether a UE corresponds to an MTC or delay tolerant UE can be determined through the delay tolerant indicator in response to the RRC connection request message.

Receiving an overload start message, the BS transmits the RRC connection reject message to the MTC UE if it is determined that overload has occurred at S1330.

If the delay tolerance indicator is not taken into consideration, the BS transmits extended wait time information by incorporating the information into the RRC connection reject message irrespective of whether the delay tolerance indicator is included in the RRC connection request message.

If the delay tolerance indicator is taken into consideration, the BS transmits the RRC connection reject message in response only to the RRC connection request message including a delay tolerance indicator; and at this time, the RRC connection reject message contains extended wait time information.

If it is determined that overload has not occurred in the core network, the BS transmits the RRC connection setup message to the MTC UE at S1340.

Next, the BS receives the RRC connection setup completion message from the MTC UE at S1350.

The BS can recognize that the corresponding UE is a delay tolerant UE if a delay tolerance indicator is included in the RRC connection request message already received by the BS or the delay tolerance indicator is included in a currently received RRC connection setup completion message. However, as descried above (the case where transmission of the delay tolerance indicator is carried out selectively), even if the delay tolerance indicator is configured such that it is transmitted being included in the RRC connection setup completion message, the RRC connection setup completion message can be transmitted without including the delay tolerance indicator depending on situations. Therefore, even when the MTC UE is a delay tolerant UE, an delay tolerance indicator may not be included in the RRC connection request message and the RRC connection setup completion message received by the BS.

The BS, recognizing conditions of the core network, can determine whether overload has occurred in the core network at S1360. The BS can determine overload in the core network based on an overload start message received from the MME. At this time, the overload start message may correspond to a global overload start message or an MTC overload start message.

In the case where a method not taking account of delay tolerance indicator is employed, the BS can determine occurrence of overload in the core network based on the global overload start message. The BS, receiving the global overload start message from the MME, can determine that overload has occurred in the core network.

In the case of employing a method taking account of a delay tolerance indicator, the BS can determine occurrence of overload in the core network based on the MTC overload start message. The BS, by receiving an MTC overload start message from the MME, can assume an overload occurrence situation of the core network for an MTC UE which has transmitted an RRC connection request message or an RRC connection setup message by incorporating the delay tolerance indicator therein. The BS transmits an RRC connection release message to the MTC UE if it is determined that overload has occurred from the overload start message received at S1370.

It may be difficult to determine whether the corresponding UE is an MTC or a delay tolerant UE, too, if the delay tolerance indicator is transmitted being included in the RRC connection setup completion message but the transmission of the delay tolerance indicator is carried out selectively. Therefore, since the BS can check from the delay tolerance indicator whether the corresponding UE is an MTC or a delay tolerant UE if the delay tolerance indicator is transmitted being included in the RRC connection setup completion message and the transmission of the delay tolerance indicator is not selective, the BS can determine occurrence of overload based on the MTC overload start message and transmit an RRC connection release message including extended wait time information only to the MTC or delay tolerant UE.

When the occurrence of overload is determined based on the MTC overload occurrence message, the BS transmits the RRC connection release message to the corresponding UE only for the case where an RRC connection request message including the delay tolerance indicator is received or an RRC connection setup completion message including the delay tolerance indicator is received; at this time, the RRC connection release message incorporates extended wait time information.

If it is determined that overload has not occurred in the core network, the BS establishes RRC connection with the MTC UE at S1380.

In what follows, embodiments of the present invention will be described in detail with reference to appended drawings.

### Embodiment 1

### A Method not Taking Account of Delay Tolerance Indicator

FIG. 14 is a flow chart briefly illustrating the operation among an MTC UE, a BS, and an MME in an embodiment 1 where a delay tolerance indicator is not taken into account in a system to which the present invention is applied.

With reference to FIG. 14, the BS receives a global overload start message from the MME at S1410 and recognizes occurrence of overload in a core network before receiving an RRC connection request message from the MTC UE.

The MTC UE activates the T300 timer and transmits an RRC connection request message to the BS at S1420.

As described above, the delay tolerance indicator can be configured such that the indicator is transmitted to the BS being included in an RRC connection request message or being included in an RRC connection setup completion message. Also, even after the delay tolerance indicator has been determined to be transmitted to the BS being included in the RRC connection request message, the delay tolerance indicator may or may not be included in the RRC connection request message depending on a situation.

Therefore, the RRC connection request message may or may not be include the delay tolerance indicator.

Since the BS is informed that overload has occurred in a current core network, an RRC connection reject message is transmitted to the corresponding UE at S1430. At this time, the BS transmits extended wait time information to an UE by incorporating the information into the RRC connection reject message irrespective of whether the delay tolerance indicator is included in the RRC connection request message.

If a UE receiving the RRC connection reject message is a delay tolerant UE, the UE checks the information about extended wait time included in the RRC connection reject message and then waits for a time period of the extended wait time without attempting RRC connection establishment.

If a UE receiving the RRC connection reject message is a delay non-tolerant UE, the UE ignores the extended wait time information or skip the corresponding field for recognition.

The BS receives a global overload end message indicating that overload of the core network has ended at S1440. The BS can recognize that overload of the core network has ended through the global overload end message received.

The delay tolerant UE re-transmits the RRC connection request message to the BS after a time period of extended wait time at S1450. With reference to FIG. 14, since overload in the core network has disappeared, RRC connection can be established in a normal manner. At this time, it was assumed for the convenience of description that overload in the core network disappears before the extended wait time expires; if the core network is still overloaded even after the extended wait time is passed and the UE re-transmits the RRC connection request message, the BS can re-transmit an RRC connection reject message including the extended wait time information to the UE.

In addition, although the embodiment of FIG. 14 describes a case where a global overload start message is received before the BS receives an RRC connection request message, the present invention can be equally applied to a case where the BS receives the global overload start message after the BS transmits the RRC connection setup message.

In the case where transmission of a delay tolerance indicator is performed selectively, the BS does not take into account whether the delay tolerance indicator is included in the RRC connection setup completion message or the corresponding UE is a delay tolerant UE; and upon recognizing occurrence of the core network, can transmit an RRC connection release message. At this time, the RRC connection release message may incorporate extended wait time information.

In the case where transmission of a delay tolerance indicator is not selectively performed, the BS can check whether the corresponding UE is a delay tolerant UE through a delay tolerance indicator included in either of the RRC connection setup completion message and the RRC connection request message already received. Therefore, in this case, the BS can transmit the RRC connection release message incorporating extended wait time information only to MTC UEs which have been found to be delay tolerant UEs.

If a UE receiving the RRC connection release message is a delay tolerant UE, the UE check extended wait time information included in the RRC connection release message and then waits for a time period of the extended wait time without attempting RRC connection establishment. If a UE receiving the RRC connection release message is a delay non-tolerant UE, the UE ignores the extended wait time information or skip the corresponding field for recognition.

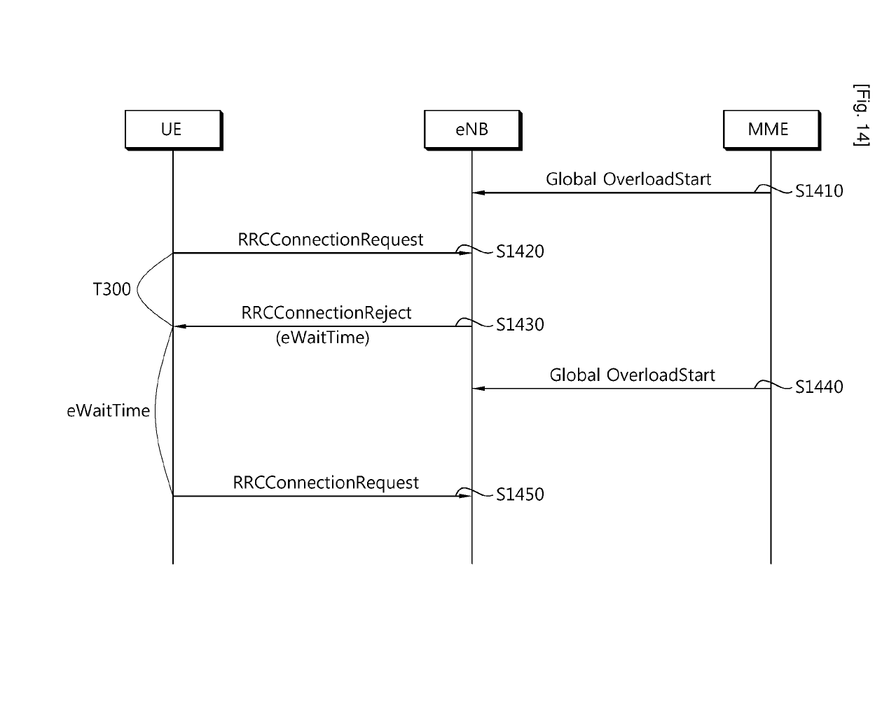

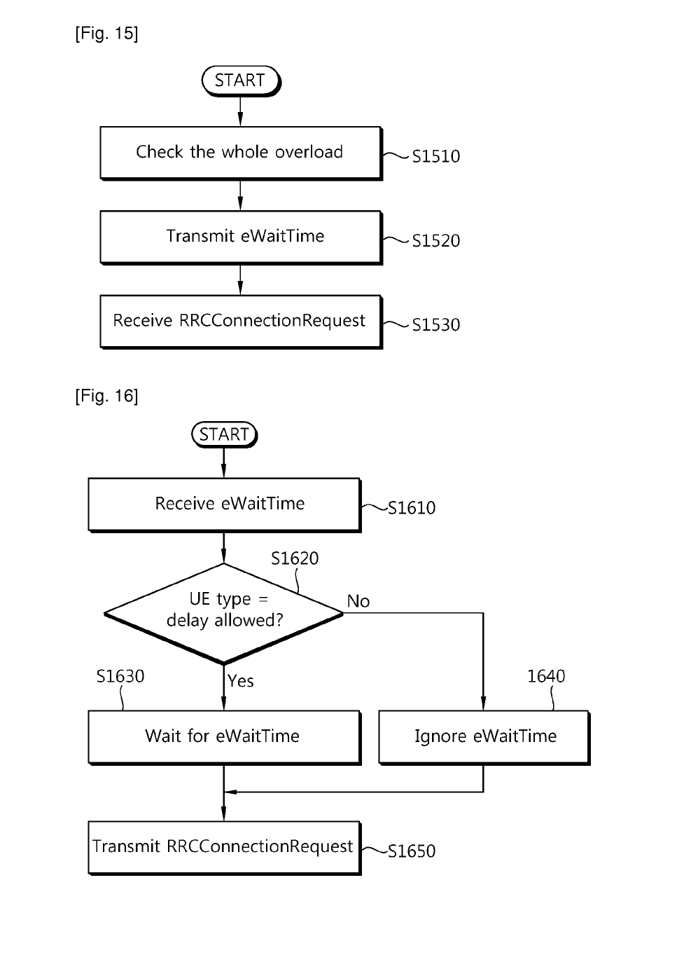

FIG. 15 is a flow chart briefly illustrating the operation of a BS of the embodiment 1 in terms of transmission of extended wait time information.

The BS performs a procedure for establishing RRC connection with an MTC UE and checks overload of the core network at S1510. Whether overload has occurred in the core network can be checked from a global overload start message received from the MME.

The BS, recognizing overload of the core network, transmits extended wait time information at S1520. Depending on the time when overload of the core network is detected, the extended wait time information can be transmitted being included in an RRC connection reject message or RRC connection release message.

If the BS receives an RRC connection request message from a UE while recognizing the occurrence of overload in the core network, the corresponding UE transmits the extended wait time information by incorporating the information into the RRC connection reject message irrespective of whether the corresponding UE is a delay tolerant UE, namely, whether a delay tolerance indicator is included in the RRC connection request message.

Meanwhile, while recognizing the occurrence of overload in the core network, if an RRC connection setup completion message is received from a UE, the BS transmits an RRC release message including extended wait time information to a UE irrespective of whether the corresponding UE is a delay tolerant UE when transmission of a delay tolerance indicator is performed selectively; on the other hand, if transmission of a delay tolerance indicator is not performed selectively and the corresponding UE is a delay tolerant UE, an RRC connection release message including extended wait time information can be transmitted to the UE.

If an MTC UE receiving extended wait time information is a delay tolerant UE, the BS receives an RRC connection request message re-transmitted from the MTC UE after the extended wait time is passed at S1530.

FIG. 16 is a flow chart briefly illustrating the operation of an MTC UE of the embodiment 1 processing extended wait time information.

An MTC UE carries out a procedure for establishing RRC connection with a BS. While or after RRC connection is established, if the BS recognizes overload of the core network, the MTC UE receives extended wait time information from the BS at S1610.

Depending on the time when overload of the core network is detected by the BS, the extended wait time information can be transmitted being included in an RRC connection reject message or RRC connection release message.

The received extended wait time information is processed differently according to the type of MTC UE at S1620.

If the MTC UE receiving extended wait time information is a delay tolerant UE, the MTC UE stops an RRC connection request and waits for the duration of extended wait time at S1630.

If a UE receiving extended wait time is a delay non-tolerant UE, the UE may ignore the extended wait time information or skip recognition of the corresponding field at S1640.

Afterwards, the UE re-transmits an RRC connection request message to the BS at S1650.

### Embodiment 2

### A Method Taking Account of Delay Tolerance Indicator

FIG. 17 is a flow chart briefly illustrating the operation between an MTC UE, a BS, and an MME in an embodiment 2 where a delay tolerance indicator is taken into account in a system to which the present invention is applied. In the embodiment 2, for the convenience of description, it is assumed that an MTC overload start message is applied only for a delay tolerant UE to reject an RRC connection request or release an established RRC connection.

With reference to FIG. 17, the BS receives an MTC overload start message from the MME at S1710 and recognizes occurrence of overload in a core network before receiving an RRC connection request message from the MTC UE.

The MTC UE activates the T300 timer and transmits an RRC connection request message to the BS at S1720. In the case of FIG. 17, a delay tolerant message is not included in the RRC connection request message. If the RRC connection request message includes a delay tolerance indicator, it can be processed in the same way as FIG. 11.

In response to an RRC connection request message received, the BS transmits an RRC connection setup message to the MTC UE at S1730. With reference to FIG. 17, the BS does not transmit an RRC connection reject message for an RRC connection request message not including a delay tolerance indicator since the BS has already received an MTC overload start message from the MME.

The MTC UE which has received the RRC connection setup message stops the T300 timer and transmits an RRC connection setup completion message at S1740. In the case of FIG. 17, if the MTC UE is a delay tolerant UE, since the delay tolerance indicator is not included in the RRC connection request message, the delay tolerance indicator is transmitted being included in the RRC connection setup completion message.

The BS checks the delay tolerance indicator from the RRC connection setup completion message received and transmits an RRC connection release message including is extended wait time information in response to the checking result at S1750. In the case of FIG. 17, since the BS has already received the MTC overload start message from the MME, if the corresponding MTC UE is found to be a delay tolerant UE through the delay tolerance indicator, an RRC connection reject message including extended wait time information or an RRC connection release message including the extended wait time information is transmitted.

The MTC UE re-transmits the RRC connection request message after waiting for a time period of the extended wait time at S1770. FIG. 17 shows a situation where the BS receives an MTC overload end message from the MME before the extended wait time expires at S1760; therefore, the BS can transmit the RRC connection setup message to the MTC UE. Different from FIG. 17, if the MTC overload is not terminated after the extended wait time, the steps described in detail above can be taken again between the BS and the MTC UE.

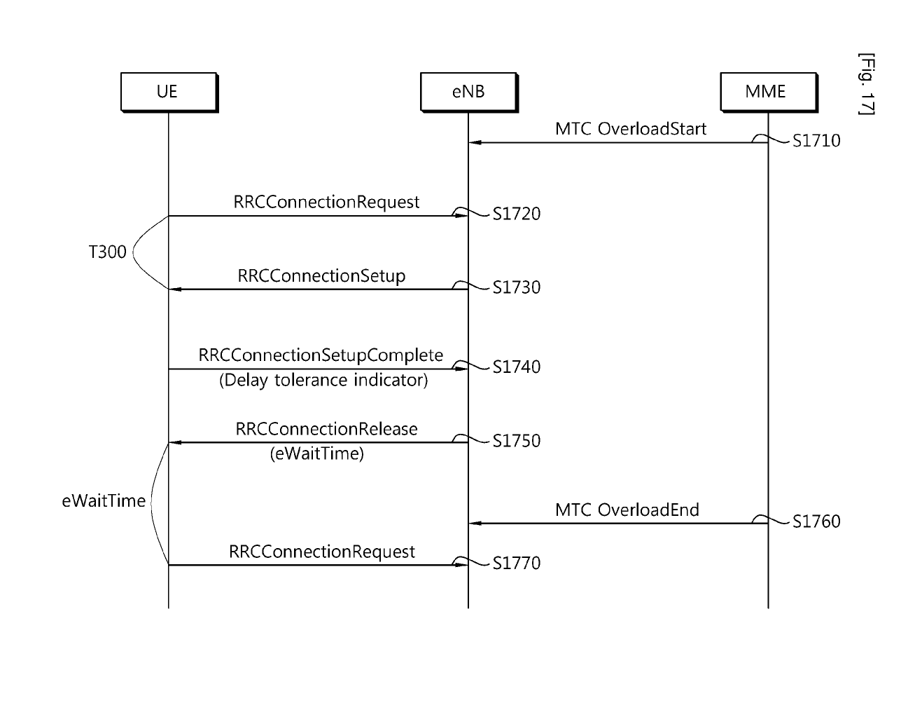

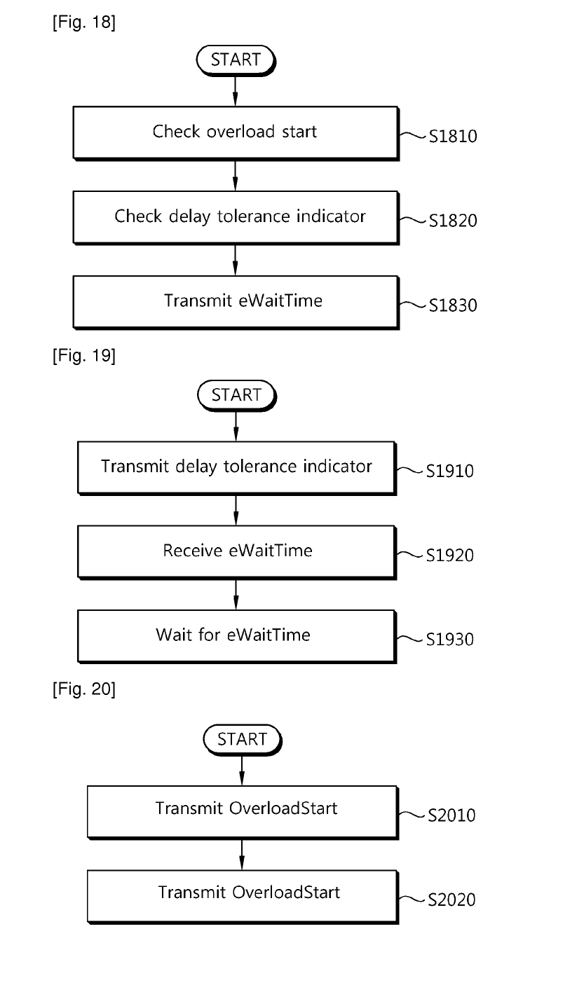

FIG. 18 is a flow chart briefly illustrating the operation of a BS of the embodiment 2 in terms of transmission of extended wait time information.

The BS checks occurrence of overload in a core network while or after establishing RRC connection with a UE at S1810. The BS can check the occurrence of overload in the core network through an MTC overload start message.

The BS examines whether a UE currently requesting RRC connection or a UE for which RRC connection has been already established transmitted a delay tolerance indicator at S1820.

The BS transmits extended wait time information to the corresponding UE if it is confirmed that the delay tolerance indicator has been transmitted at S1830. The extended wait time information may be transmitted being included in an RRC connection reject message or RRC connection release message depending on the time when the BS recognizes occurrence of overload of the core network.

FIG. 19 is a flow chart briefly illustrating the operation of an MTC UE of the embodiment 2 processing extended wait time information.

An MTC UE, which is a delay tolerant UE, while carrying out a procedure for RRC connection with a BS, transmits a delay tolerance indicator by incorporating the indicator into an RRC connection request message or RRC connection setup completion message at S1910.

If the BS recognizes overload of the core network, the UE receives extended wait time information from the BS at S1920. The BS can recognize the overload situation of the core network from an MTC overload start message transmitted from the MME. At this time, according to the time when the BS recognizes the overload situation of the core network, the extended wait time information may be transmitted being included in an RRC connection reject message or RRC connection release message.

The MTC UE, based on the extended wait time received, waits for the extended wait time without requesting RRC connection at S1930. The MTC UE can transmit an RRC connection request message to the BS after the extended wait time is passed.

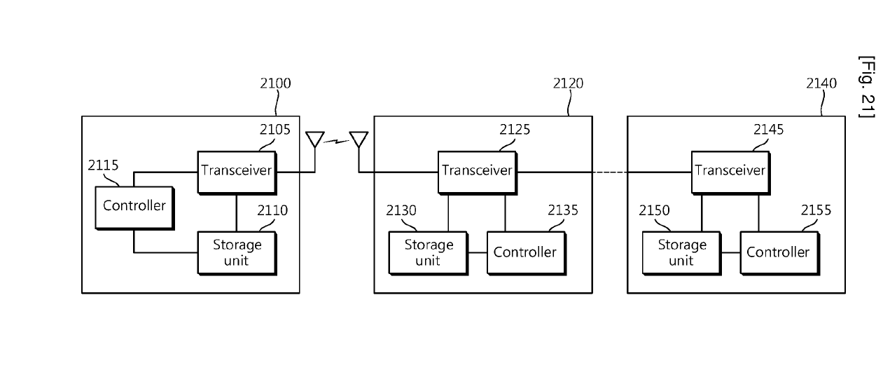

FIG. 20 is a flow chart briefly illustrating the operation of an MME in the embodiment 1 and 2.

The MME, if overload occurs in a core network, transmits an overload start message to a BS at S2010.

The overload start message may be a global overload start message or an MTC overload start message.

The MME, depending on a configuration, can examine overload in the core network and compose a global overload start message indicating rejection of RRC connection requests or release of established RRC connections for all of the UEs and transmit the message to the BS.

Also, depending on a configuration, the MME can examine overload in the core network and compose an MTC overload start message indicating rejection of RRC connection requests or release of established RRC connections for MTC or delay tolerant UEs and transmit the message to the BS.

In addition, depending on a configuration, the MME can examine overload in the core network and prioritize MTC UEs, delay tolerant UEs, or all of the UEs in phases and composes an MTC overload start message indicating rejection of RRC connection requests or release of established RRC connections and transmit the message to the BS.

If overload situation of the core network transmitted through the overload start message is terminated, the MME composes a corresponding end message and transmits the message to the BS at S2020.

For the convenience of description, the embodiment 2 assumed a situation where the MTC overload start message is applied only for a delay tolerant UE for rejecting RRC connection requests or releasing established RRC connections; however, the present invention is not limited to the above and as described in detail above, the MTC overload start message can be defined and applied in various ways to separately carry out an RRC connection setup procedure for MTC UEs or delay tolerant UEs.

FIG. 21 briefly illustrates the configuration of an MTC UE, a BS, and an MME in a system to which the present invention is applied.

The MTC UE 2100 comprises a transceiver 2105, a storage unit 2110, and a controller 2115.

The MTC UE 2100 transmits and receives required data through the transceiver 2105.

The storage unit 2110 can store data required for the MTC UE 2100 to perform communication. The storage unit 2100 can store information measured by the MTC UE, a delay tolerance indicator to be transmitted to the BS, extended wait time information received from the BS, etc.

The controller 2115 is connected to the transceiver 2105 and the storage unit 2110; and controls them. The controller 2115 performs a procedure required for RRC connection with the BS; if connection is established with the BS, measured information is transmitted to an MTC server through the BS. Also, the controller 2115 composes a delay tolerance indicator and a message required for performing an RRC connection procedure, that is, an RRC connection request message and RRC connection setup completion message; and transmits the RRC connection request message or RRC connection setup completion message by incorporating the delay tolerance indicator into the message. After receiving extended wait time information from the BS, the controller 2115 restarts the operation for establishing RRC connection after the extended wait time.

The BS 2120 comprises a transceiver 2125, a storage unit 2130, and a controller 2135.

The BS 2120 performs communication with an MTC UE 2100 and an MME through the transceiver 2125.

The storage unit 2130 can store information required for the BS 2120 to perform communication. The storage unit 2130 can store information about a delay tolerance indicator received from the MTC UE or information about RRC connection establishment; and store measurement information received from the MTC UE. Also, the storage unit 2130 can store information about overload conditions of the core network or information about extended wait time received from the MME.

The controller 2135 is connected to the transceiver 2125 and the storage unit 2130; and controls them. The controller 2135 controls the execution of the function/operation provided by the present invention. For example, the controller 2135 controls an RRC connection setup procedure in association with the MTC UE. Also, the controller 2135 determines the type of the corresponding UE through a delay tolerance indicator and transmits extended wait time information to the corresponding UE if it is determined such that connection to the MTC UE is rejected or released.

The MME 2140 comprises a transceiver 2145, a storage unit 2150, and a controller 2155.

The MME 2140 performs communication with the BS through the transceiver 2145.

The storage unit 2150 can store information required for the MME 2140 to operate a network. The storage unit 2150 can store information about load of the core network or extended wait time information to be transmitted to the BS.

The controller 2155 is connected to the transceiver 2145 and the storage unit 2150; and controls them. The controller 2155 checks the status of the core network and if necessary, can compose a message representing the load situation of the core network and transmit the message to the BS through the transceiver 2145.

In the exemplary systems described above, methods have been described based on a series of phases or flow charts in form of blocks but the present invention is not limited to the order of the phases; some phases may follow an order or form phases different from the description above or may be performed simultaneously. Also, it should be clearly understood by those skilled in the art that the phases shown in the flow charts are not exclusive but different phases may be added or one or more phases of the flow charts may be removed without departing from the technical scope of the present invention.

The embodiments described above include various forms of examples. Although it is not possible to describe all the possible combinations to show various forms of examples, those skilled in the art may easily understand that different combinations are possible. Therefore, it should be interpreted that the present invention comprises all the possible modifications, revisions, and changes belonging to the technical scope defined by the appended claims.

1. A method for establishing Radio Resource Control (RRC) connection of a Base Station (BS), in a Machine Type Communication (MTC) system, comprising:
determining load conditions of a core network; and
transmitting wait time information to a User Equipment (UE) by using RRC connection reject message or RRC connection release message if the core network is determined to be overloaded, the wait time information being recognized by a UE allowing a delay in establishing RRC connection and applied for the UE.

2. The method of claim 1, wherein the wait time information is transmitted to MTC UEs or only to UEs allowing a delay in establishing RRC connection and whether a UE is an MTC UE or a UE allowing a delay in establishing RRC connection is determined through a delay tolerance indicator received from the UE and the indicator is transmitted being included in an RRC connection request message or an RRC connection setup completion message.

3. The method of claim 1, wherein load conditions of the core network are determined based on an overload generation message of the core network received from a Mobility Management Entity (MME).

4. The method of claim 3, wherein the overload generation message directs to apply measures according to overload conditions for RRC connection requests of all of the UEs or only for RRC connections if the amount of load of the core network is higher than a predetermined first overload threshold value whereas the overload generation message directs to apply measures according to overload conditions only for MTC UEs or RRC connection requests of UEs allowing a delay in establishing RRC connection or RRC connections if the amount of load of the core network is higher than a predetermined second overload threshold value and lower than the first overload threshold value.

5. The method of claim 3, wherein the overload generation message includes an overload processing indicator indicating whether to apply measures according to overload conditions of a core network for all of the UEs or MTC UEs or only for the UEs allowing a delay in establishing RRC connection; and the BS applies the measures according to overload conditions of the core network based on indication of the overload processing message.

6. A method for establishing a Radio Resource Control (RRC) connection in a Machine Type Communication (MTC) system, comprising:
receiving wait time information through an RRC connection reject message or an RRC connection release message from a Base Station (BS); and
transmitting an RRC connection request to the BS after wait time specified by the wait time information is passed.

7. The method of claim 6, wherein before the wait time information is received, a delay tolerance indicator indicating allowance of a delay in establishing RRC connection is transmitted to a BS.

8. The method of claim 7, wherein the delay tolerance indicator is transmitted being included in an RRC connection request message.

9. The method of claim 7, wherein the delay tolerance indicator is transmitted being included in an RRC connection completion message.

10. The method of claim 6, wherein before the wait time information is received, it is decided whether to transmit to a BS a delay tolerance indicator indicating allowance of a delay in establishing RRC connection; and if transmission is determined, the delay tolerance indicator is transmitted to the BS.

11. The method of claim 10, wherein the delay tolerance indicator is transmitted being included in an RRC connection request message.

12. The method of claim 10, wherein the delay tolerance indicator is transmitted being included in an RRC connection completion message.

13. A Base Station (BS), comprising:
a transmission and reception unit transmitting and receiving messages for Radio Resource Control (RRC) setup; and
a controller controlling RRC setup, the controller, determining that a core network is under overload conditions, transmitting wait time information to a User Equipment (UE) by using an RRC connection reject message or an RRC connection release message, where the wait time information is recognized by a UE allowing a delay in establishing RRC connection and applied for the UE.

14. The Base Station of claim 13, wherein the wait time information is transmitted only for Machine Type Communication (MTC) UEs or only for the UEs allowing a delay in establishing RRC connection; and whether a UE is an MTC UE or a UE allowing a delay in establishing RRC connection determined through a delay tolerance indicator received from the UE; and the wait time information is transmitted being included in an RRC connection reject message or an RRC connection release message.

15. The Base Station of claim 13, wherein load conditions of the core network are determined based on an overload generation message of a core network received from a Mobility Management Entity (MME).

16. A User Equipment (UE), comprising:
a transmission and reception unit transmitting and receiving messages for Radio Resource Control (RRC) setup; and
a controller controlling RRC setup, the controller transmitting an RRC connection request to a Base Station (BS) after wait time specified by wait time information received from the BS is passed, where the wait time information is included in an RRC connection reject message or an RRC connection release message transmitted from the BS.

17. The User Equipment of claim 16, wherein the controller transmits a delay tolerance indicator to a BS through the transmission and reception unit, the delay tolerance indicator indicating that a delay in establishing RRC connection can be allowed before the wait time information is received.

18. The User Equipment of claim 17, wherein the delay tolerance indicator is transmitted being included in an RRC connection request message or an RRC connection completion message.

19. The User Equipment of claim 16, wherein the controller, before receiving the wait time information, decides whether to transmit to a BS a delay tolerance indicator indicating allowance of a delay in establishing RRC connection; and if transmission is determined, transmits the delay tolerance indicator to the BS.

20. The User Equipment of claim 19, wherein the delay tolerance indicator is transmitted being included in an RRC connection request message or an RRC connection completion message.
